(19) United States
(12) Patent Application Publication
(10) Pub. No.: US 2006/0202576 A1
(43) Pub. Date: Sep. 14, 2006

(54) Cooling fan with outboard bearings

(76) Inventors: Wade D. Vinson, Magnolla, TX (US); John P. Franz, Houston, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/077,092

(22) Filed: Mar. 10, 2005

(51) Int. Cl. H02K 7/00; H02K 5/16; F04B 17/00

(52) U.S. Cl. 310/90; 310/67 R; 417/423.12

(57) ABSTRACT

A cooling fan comprising a housing that connects to a computer chassis supporting an electronic component. A fan blade assembly is disposed within the housing. A windings section is fixably mounted within said housing. The windings section forms a body having opposite ends and a bore there between. A first bearing is disposed outboard of one end of the windings section and rotatably supports the fan blade assembly within the housing.

### BACKGROUND

Computer systems include numerous electrical components that draw electrical current to perform their intended functions. For example, a computer's microprocessor or central processing unit (“CPU”) requires electrical current to perform many functions such as controlling the overall operations of the computer system and performing various numerical calculations. Generally, any electrical device through which electrical current flows produces heat. The amount of heat any one device generates generally is a function of the amount of current flowing through the device.

Typically, an electrical device is designed to operate correctly within a predetermined temperature range. If the temperature exceeds the predetermined range (i.e., the device becomes too hot), the device may not function correctly, thereby potentially degrading the overall performance of the computer system. Thus, many computer systems include cooling systems to regulate the temperature of their electrical components. One type of cooling system is a forced air system that relies on one or more cooling fans to blow air over the electronic components in order to cool the components.

The cubic feet per minute (“CFM”) of air that can be moved across an electric device is an important factor in how much heat can be removed from the device. Thus, the capacity of a cooling fan is a critical factor in selecting an air mover for use in a cooling application. The CFM that a cooling fan can produce is governed a number of factors including: the total area of the blades generating the airflow, the free area provided for airflow through the fan, the design of the blades, and the power generated by the electric motor.

Electric motors are used to power many cooling fans. Electric motors utilize a cylindrical windings section with magnets disposed inside or outside the cylinder. As electrical current flows through the windings, the magnets rotate about the axis of the motor. The power generated by an electric motor is partially dependent on the size of the windings section. In many computer cooling applications, the size of a cooling fan is constrained, such as by the chassis envelope. Thus, the size of the windings section, and many other components within the fan, are also constrained.

### BRIEF SUMMARY

The problems noted above are solved in large part by a cooling fan comprising a housing that connects to a computer chassis supporting an electronic component. A fan blade assembly is disposed within the housing. A windings section is fixably mounted within said housing. The windings section forms a body having opposite ends and a bore there between. A first bearing is disposed outboard of one end of the windings section and rotatably supports the fan blade assembly within the housing.

### BRIEF DESCRIPTION OF THE DRAWINGS

For a detailed description of exemplary embodiments of the invention, reference will now be made to the accompanying drawings in which:

FIG. 1 shows a cooling fan constructed in accordance with embodiments of the invention;

FIG. 2 shows a cooling fan constructed in accordance with embodiments of the invention;

FIG. 3 shows a cooling fan constructed in accordance with embodiments of the invention; and

FIG. 4 shows a computer system comprising cooling fans constructed in accordance with embodiments of the invention.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection, or through an indirect connection via other devices and connections.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

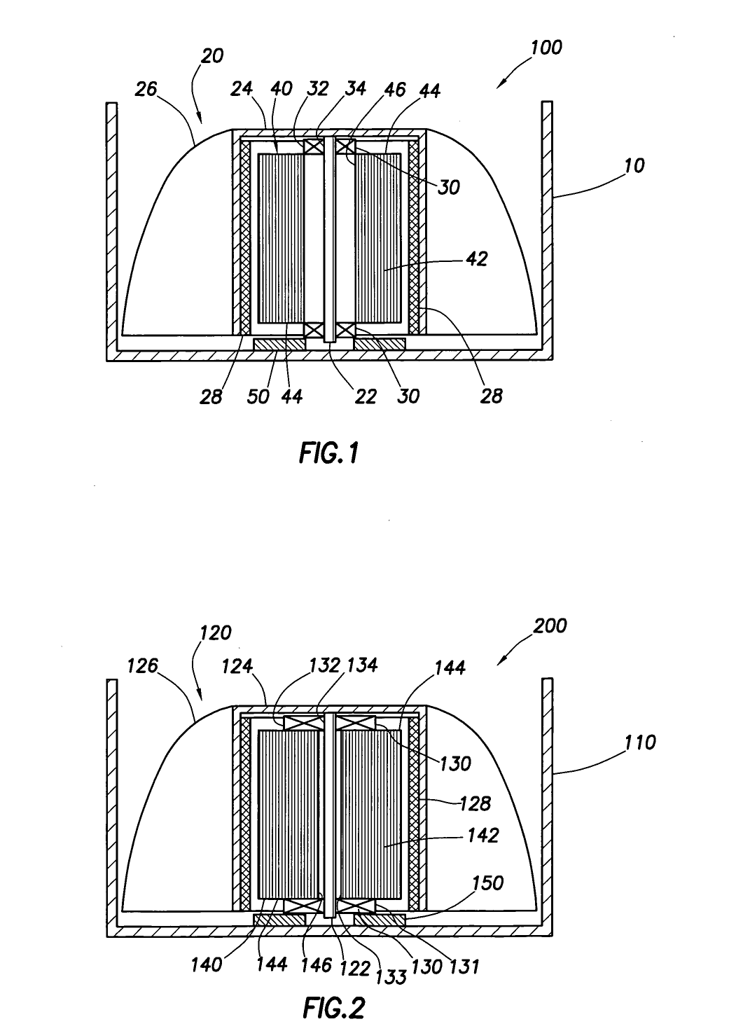

Referring now to FIG. 1, cooling fan 100 comprises housing 10, fan blade assembly 20, bearings 30, windings section 40, and circuit board 50. Blade assembly 20 comprises shaft 22, hub 24, blades 26, and magnets 28. Bearings 30 comprise an outer, stationary portion 32 and an inner rotating portion 34. Windings section 40 comprises substantially cylindrical body 42 having two ends 44 and a bore 46 therethrough. Circuit board 50 is electrically coupled to windings section 40 and comprises the electrical circuitry that provides control of the rotation of blade assembly 20.

Cooling fan 100 is especially suited for use in cooling electronic components, such as those found in computer systems. Housing 10 is constructed so as to interface with a computer chassis that supports an electronic component. Cooling fan 100 is an axial fan that generates airflow generally along an axis about which blade assembly 20 rotates. Blade assembly 20 is rotated by the interaction of magnets 28 and the magnetic field generated by an electrical current in windings section 40. Magnets 28 may be connected to hub 24, as shown, or may be connected to shaft 22 (See FIG. 3).

Blades 26 extend radially from hub 24. Shaft 22 is fixed to hub 24 and defines an axis about which blade assembly 20 rotates. Shaft 22 is rotatably supported by bearings 30 and extends through bore 46 of windings section 40. Bearings 30 are disposed outboard of windings section 40 on ends 44 such that the windings section is between the bearings. Stationary portions 32 of bearings 30 may be connected directly to windings section 40 or may otherwise fixably connected to housing 10.

By disposing bearings 30 outboard of windings section 40, the amount heat that is transferred to the bearings from the windings is decreased. This reduces the temperature at which the bearing operates. The effective life of a bearing is partially dependent on the temperature at which the bearing operates and therefore, by decreasing the heat transferred to the bearings, bearing life can be increased.

Disposing the bearings outboard of the windings also increases the amount of space available for the windings by removing the bearings from the bore of the windings. The overall size of the windings section can be increased by decreasing the diameter of the bore. Increasing the size of the windings section increases the maximum power that can be generated by the cooling fan. Additional available power allows the fan to be operated at higher speeds, thus providing greater airflow and higher differential pressures.

Further, because the bearings are not constrained by the bore through the windings section, larger diameter bearings can be used. Larger diameter bearings may provide a longer service life than smaller bearings, may be less expensive to produce, and may permit the use of better lubricants and/or more lubricant volume. Bearings may be ball bearings, sleeve bearings, fluid dynamic bearings, or other type bearings that support rotation of the shaft. In certain embodiments, the bearings may be fully outboard of the windings such that the inner surface of the bearings contacts the outside of the windings and the outer surface contacts the inside of the hub.

Referring now to FIG. 2, cooling fan 200 comprises housing 110, fan blade assembly 120, bearings 130, windings section 140, and circuit board 150. Blade assembly 120 comprises shaft 122, hub 124, blades 126, and magnets 128. Bearings 130 comprise an outer, stationary portion 132 and an inner rotating portion 134. Windings section 140 comprises substantially cylindrical body 142 having two ends 144 and a bore 146 therethrough. Circuit board 150 is electrically coupled to windings section 140 and comprises the electrical circuitry that provides control of the rotation of blade assembly 120. Bearings 130 have on outer edge 131 that extends beyond the edge 133 of bore 146 such that the overall size of the bearings is increased and/or the diameter of the bore is reduced.

Referring now to FIG. 3, cooling fan 300 comprises housing 210, fan blade assembly 220, bearings 230, windings section 240, and circuit board 250. Blade assembly 220 comprises shaft 222, hub 224, blades 226, and magnets 228. Windings section 240 comprises substantially cylindrical body 242 having two ends 244 and a bore 246 therethrough. Circuit board 250 is electrically coupled to windings section 240 and comprises the electrical circuitry that provides control of the rotation of blade assembly 220. Magnets 228 are disposed on shaft 222 and disposed within bore 246 of windings section 240. Bearings 230 are positioned outboard of windings section 240 and have a larger outer diameter 231 than the diameter 233 of bore 246.

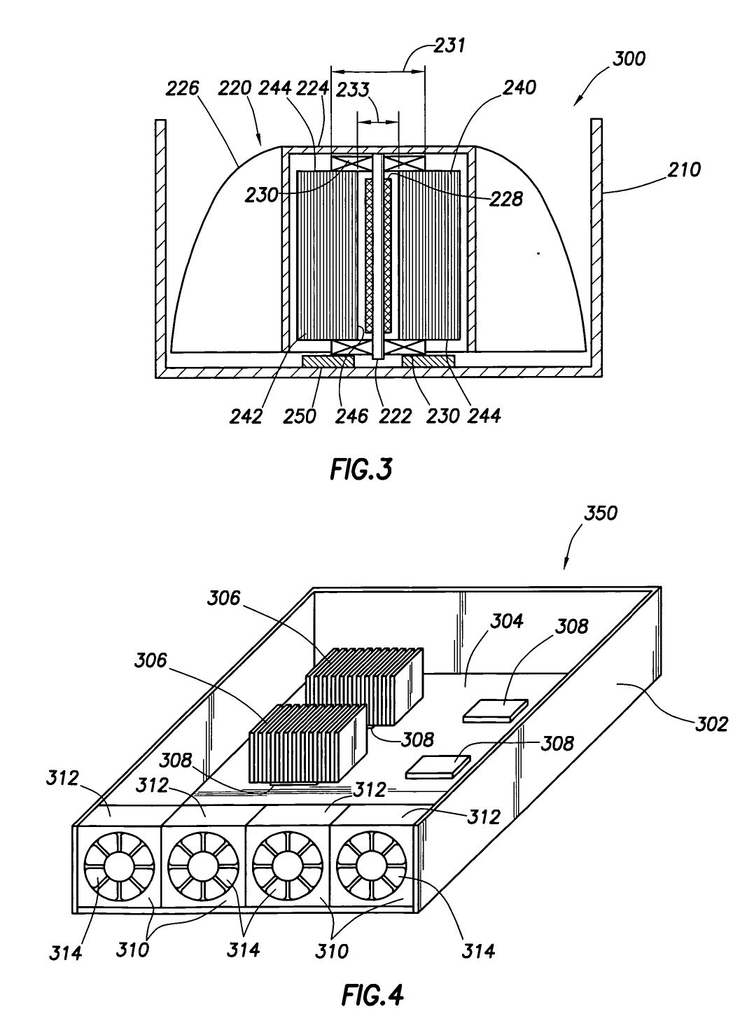

Referring now to FIG. 4, a computer assembly 350 comprises chassis 302, motherboard 304, heat sinks 306, electronic components 308, and cooling fans 310. Each cooling fan 310 comprises a housing 312 surrounding a blade assembly 314 that is rotatably supported by bearings positioned outboard of the windings of the electric motor powers the fan. Cooling fans 310 are arranged so as to generate an airflow that cools electronic component 308. Heat sinks 306 may be arranged so as to be directly in the airflow generated by fans 310. Heat sinks 306 are coupled to electronic components so that the heat generated by the electronic component is dissipated to the airflow through the increased surface area of the heat sink.

The above discussion is meant to be illustrative of the principles and various embodiments of the present invention. Numerous variations and modifications will become apparent to those skilled in the art once the above disclosure is fully appreciated. For example, cooling fans as described above may be used in any electronics device that utilizes forced air cooling. It is intended that the following claims be interpreted to embrace all such variations and modifications.

What is claimed is:

1. A cooling fan comprising:
a housing operable to connect to a computer chassis supporting an electronic component;
a fan blade assembly disposed within said housing;
a windings section fixably mounted within said housing, wherein said windings section forms a body having opposite ends and a bore there between; and
a first bearing disposed outboard of one end of said windings section, wherein said first bearing rotatably supports said fan blade assembly within said housing.

2. The cooling fan of claim 1, further comprising a second bearing disposed outboard of the opposite end of said windings section, wherein said second bearing rotatably supports said fan blade assembly within said housing.

3. The cooling fan of claim 2, further comprising a shaft connected to said fan blade assembly and connected to said first and second bearings.

4. The cooling fan of claim 3, wherein said shaft is disposed through the bore of said windings section.

5. The cooling fan of claim 3, further comprising a magnet disposed on said shaft.

6. The cooling fan of claim 1, wherein said blade assembly comprises:
a hub disposed around said windings section; and
a magnet disposed on said hub.

7. The cooling fan of claim 2, wherein said first and second bearings have a diameter larger than the bore.

8. A cooling fan comprising:
a housing operable to connect to a computer chassis supporting an electronic component;
a fan blade assembly disposed within said housing;
a shaft connected to said housing;
first and second bearings rotatably supporting said shaft; and
a windings section mounted within said housing and disposed between said first and second bearings.

9. The cooling fan of claim 8, wherein said windings section comprises a body having opposite ends and a bore there between.

10. The cooling fan of claim 9, wherein said shaft is disposed through the bore of said windings section.

11. The cooling fan of claim 9, wherein said first and second bearings have a diameter larger than the bore.

12. The cooling fan of claim 9, wherein said first bearing is disposed outboard of one end of said windings section and said second bearing is disposed outboard of the opposite end of said windings section.

13. The cooling fan of claim 8, further comprising a magnet disposed on said shaft.

14. The cooling fan of claim 8, wherein said blade assembly comprises:
a hub disposed around said windings section; and
a magnet disposed on said hub.

15. A computer system comprising:
a chassis;
an electronic component disposed within said chassis; and
a cooling fan disposed within said chassis, wherein said cooling fan comprises:
a fan blade assembly disposed within said housing;
a shaft connected to said fan blade and rotatably supported by a first bearing;
a windings section disposed about said shaft, wherein said first bearing is outboard of said windings section.

16. The computer system of claim 15, wherein said windings section comprises a body having opposite ends and a bore there between, wherein said shaft is disposed through the bore of said windings section.

17. The computer system of claim 15 further comprising a second bearing disposed outboard of said windings section, wherein said windings section is between said first and second bearings.

18. The computer system of claim 17, wherein said first and second bearings have a diameter larger than the bore.

19. The computer system of claim 17, wherein said first bearing is disposed outboard of one end of said windings section and said second bearing is disposed outboard of the opposite end of said windings section.

20. The computer system of claim 15 further comprising a heat sink thermally coupled to said electronic component.

21. A cooling fan comprising:
a housing operable to connect to a computer chassis supporting an electronic component;
a fan blade assembly disposed within said housing;
a windings section fixably mounted within said housing, wherein said windings section forms a body having opposite ends and a bore there between; and
means for rotatably supporting said fan blade assembly within said housing, wherein said means for rotatably supporting is disposed outboard of said windings section.
